(19) United States
(12) Patent Application Publication
(10) Pub. No.: US 2010/0045784 A1
(43) Pub. Date: Feb. 25, 2010

(54) IMAGE DISPLAY APPARATUS AND IMAGE DISPLAY METHOD

(76) Inventors: Kouji OKAZAKI, Tokyo (JP); Akihiro Nagase, Tokyo (JP); Takahiko Yamamuro, Tokyo (JP); Shuichi Kagawa, Tokyo (JP); Hiroaki Sugiura, Tokyo (JP)

Correspondence Address: BIRCH STEWART KOLASCH & BIRCH, PO BOX 747, FALLS CHURCH, VA, 22040-0747, US

(21) Appl. No.: 12/502,091

(22) Filed: Jul. 13, 2009

(30) Foreign Application Priority Data
Aug. 22, 2008 (JP) 2008-213578
Aug. 22, 2008 (JP) 2008-213587

(51) Int. Cl. H04N 13/04

(52) U.S. Cl. 348/55; 348/E13.001

(57) ABSTRACT

An image display apparatus including a display unit having a display panel; an illuminator; a number-of-lines converter for changing each of number of lines in one frame of an image-for-left-eye signal and number of lines in one frame of an image-for-right-eye signal to a reduced number of lines; a timing generator for generating a display timing signal and an illuminating timing signal; a display controller; and an illuminator driver for causing the illuminator to apply light to the display panel at timing synchronized with the display timing signal every one frame; wherein the display unit duplicates an image signal of each line of the image-for-left-eye signal of the reduced number of lines and the image-for-right-eye signal of the reduced number of lines to produce the same plural image signals for plural lines and simultaneously writes the produced signals for plural lines in the display panel to display an image.

### BACKGROUND OF THE INVENTION

1. Field of the Invention

The present invention relates to an image display apparatus and an image display method for alternately displaying an image for left eye and an image for right eye in a time-division manner to display a stereoscopic image.

2. Description of the Related Art

A method of displaying a stereoscopic image by making an image for left eye and an image for right eye impinge on a left eye and a right eye respectively has been put to practical use. However, this method has a problem of crosstalk, by which part of an image for left eye is viewed undesirably by a right eye and/or part of an image for right eye is viewed undesirably by a left eye. In order to resolve this problem, there is proposed an image display method of reducing crosstalk between an image for left eye and an image for right eye by controlling light illumination timing of a light source for illuminating a display panel so that the light source is in an off state during image rewriting in the display panel and the light source is switched on after the image rewriting in the display panel. Refer to Japanese Patent Application Kokai Publication No. 2003-202519 (e.g., paragraphs 0084 and 0096-0097, FIGS. 14 and 16)) as Patent Document 1.

However, in the image display method disclosed in Patent Document 1, the illuminating time of the light source becomes short, and therefore there is a problem that the displayed image becomes darker than that when the light source continuously illuminates the display panel.

Further, in order to resolve the problem that the displayed image becomes dark, there is also proposed an image display method, in which plural light sources are provided for plural lines in the display panel respectively, and after the rewriting of an image for one line is finished, a light source for illuminating one line in question is turned on (e.g., refer to Patent Document 1). However, in this case, there is another problem that the apparatus needs a complicated configuration.

### SUMMARY OF THE INVENTION

It is an object of the present invention to provide an image display apparatus and an image display method that can display a brighter stereoscopic image with no crosstalk, while avoiding a complicated configuration of the apparatus.

According to the present invention, an image display apparatus includes: a display unit including a display panel for displaying an image; an illuminator for applying light to the display panel; a number-of-lines converter for receiving an image-for-left-eye signal and an image-for-right-eye signal of a stereoscopic image and for changing each of number of lines in one frame of the image-for-left-eye signal and number of lines in one frame of the image-for-right-eye signal to a reduced number of lines; a timing generator for generating a display timing signal and an illuminating timing signal on the basis of the image-for-left-eye signal of the reduced number of lines and the image-for-right-eye signal of the reduced number of lines; a display controller for alternately supplying the image-for-left-eye signal of the reduced number of lines or the image-for-right-eye signal of the reduced number of lines at timing synchronized with the display timing signal to the display unit every one frame; and an illuminator driver for causing the illuminator to apply light to the display panel at timing synchronized with the display timing signal every one frame; wherein the display unit duplicates an image signal of each line of the image-for-left-eye signal of the reduced number of lines and the image-for-right-eye signal of the reduced number of lines supplied from the display controller to produce the same plural image signals for plural lines and simultaneously writes the produced plural image signals for plural lines in the display panel to display an image.

According to the present invention, an image display method includes a step, in which a number-of-lines converter receives an image-for-left-eye signal and an image-for-right-eye signal of a stereoscopic image and changes each of number of lines in one frame of the image-for-left-eye signal and number of lines in one frame of the image-for-right-eye signal to a reduced number of lines; a step, in which a timing generator generates a display timing signal and an illuminating timing signal on the basis of the image-for-left-eye signal of the reduced number of lines and the image-for-right-eye signal of the reduced number of lines; a step, in which a display unit including a display panel alternately receives the image-for-left-eye signal of the reduced number of lines or the image-for-right-eye signal of the reduced number of lines at timing synchronized with the display timing signal every one frame, and duplicates an image signal of each line of the image-for-left-eye signal of the reduced number of lines and the image-for-right-eye signal of the reduced number of lines supplied from the display controller to produce the same plural image signals for plural lines and simultaneously writes the produced plural image signals for plural lines in the display panel to display an image; and a step, in which an illuminator applies light to the display panel for each one frame at timing synchronized with the illuminating timing signal.

In the present invention, since an image-for-left-eye signal of the reduced number of lines and an image-for-right-eye signal of the reduced number of lines are transmitted to the display unit, the receiving time for the image signal can be shortened. Further, in the present invention, since the display unit duplicates an image signal of each line of the image-for-left-eye signal of the reduced number of lines and the image-for-right-eye signal of the reduced number of lines supplied from the display controller to produce the same plural image signals for plural lines and simultaneously writes the produced plural image signals for plural lines in the display panel to display an image, the writing time in the display panel can be shortened. For these reasons, the present invention can have an advantageous effect that the illuminator can illuminate the display panel for longer time as long as crosstalk between an image for left eye and an image for right eye can be avoided, an bright image can be displayed on the display panel and crosstalk between an image for left eye and an image for right eye can be avoided. Furthermore, since there is no need to provide plural light sources corresponding to plural lines respectively, the present invention has an advantageous effect that the apparatus does not need to have a complicate configuration.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically showing a configuration of an image display apparatus according to the first to fifth embodiments (i.e., an apparatus for performing an image display method according to the first to fifth embodiments) of the present invention;

FIG. 2 is a block diagram schematically showing a configuration of a reflective liquid crystal display shown in FIG. 1;

FIG. 3 is a timing diagram showing a 2D input image signal and a 2D double-speed image signal in the first embodiment;

FIG. 4 is a timing diagram showing a 3D input image signal and a 3D double-speed image signal in the first embodiment;

FIG. 5 is an explanatory diagram showing processing performed by a number-of-lines converter and processing performed by a 3D timing generator in the first embodiment;

FIG. 6 is a timing diagram showing processing performed by a 2D timing generator in the first embodiment;

FIG. 7 is a timing diagram showing processing performed by a 3D timing generator in the first embodiment;

FIGS. 8A and 8B are explanatory diagrams showing a case where a stereoscopic image signal is an interlace signal in an image display apparatus according to the second embodiment (i.e., an apparatus for performing an image display method according to the second embodiment) of the present invention;

FIGS. 9A and 9B are explanatory diagrams showing a case where a stereoscopic image signal is an interlace signal in an image display apparatus according to the third embodiment (i.e., an apparatus for performing an image display method according to the third embodiment) of the present invention;

FIGS. 10A and 10B are explanatory diagrams showing a case where a stereoscopic image signal is an interlace signal in an image display apparatus according to the fourth embodiment (i.e., an apparatus for performing an image display method according to the fourth embodiment) of the present invention;

FIG. 11 is a timing diagram showing processing performed by a 2D timing generator and a light emitting level of a laser light source in the fifth embodiment of the present invention; and

FIG. 12 is a timing diagram showing processing performed by a 3D timing generator and a light emitting level of a laser light source in the fifth embodiment of the present invention.

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

### First Embodiment

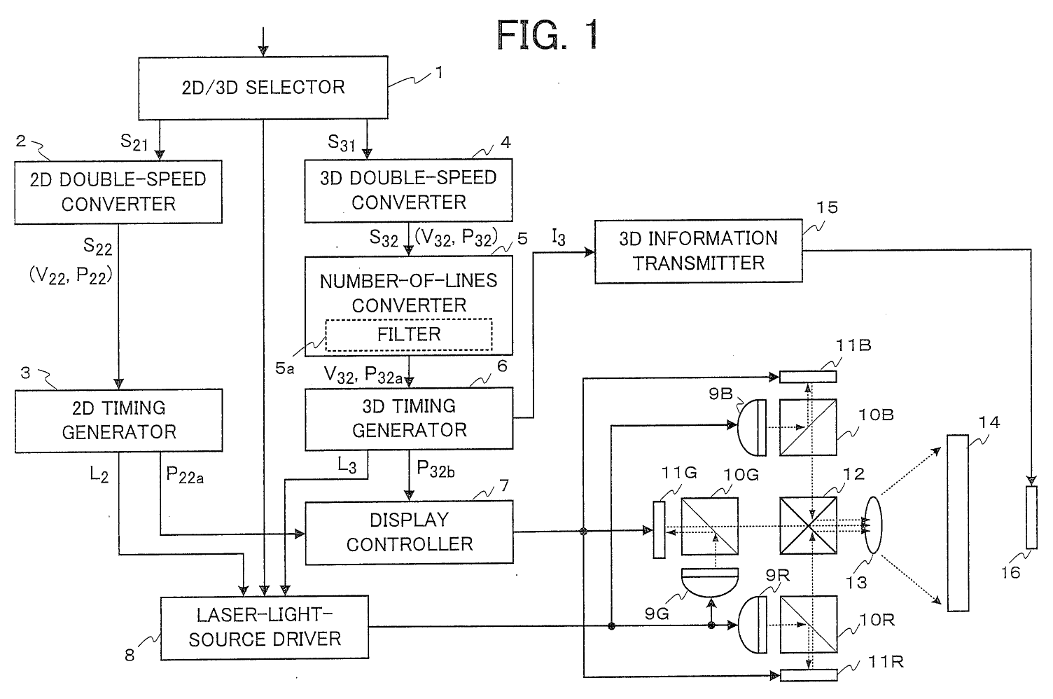

FIG. 1 is a block diagram schematically showing a configuration of an image display apparatus according to the first embodiment (i.e., an apparatus for performing an image display method according to the first embodiment) of the present invention. As shown in FIG. 1, the image display apparatus according to the first embodiment includes a two-dimensional image/a stereoscopic image (2D/3D) selector 1, a two-dimensional image (2D) double-speed converter 2, and a two-dimensional image (2D) timing generator 3. Further, the image display apparatus according to the first embodiment includes a stereoscopic image (3D) double-speed converter 4, a number-of-lines converter 5, a stereoscopic image (3D) timing generator 6, and a stereoscopic image (3D) information transmitter 15. Furthermore, the image display apparatus according to the first embodiment includes a display controller 7 and a laser-light-source driver 8.

Further, as shown in FIG. 1, the image display apparatus according to the first embodiment includes, as optical components, a red laser light source 9R, a green laser light source 9G, a blue laser light source 9B, a red-light polarizing beam splitter (PBS) 10R, a green-light polarizing beam splitter (PBS) 10G, a blue-light polarizing beam splitter (PBS) 10B, a red-light reflective liquid crystal display 11R, a green-light reflective liquid crystal display 11G, a blue-light reflective liquid crystal display 11B, a cross-dichroic prism 12, a projection lens 13, a screen 14, and three-dimensional (3D) glasses 16. Furthermore, although the first embodiment describes a rear projection image display apparatus magnifying and projecting lights (images) modulated by the reflective liquid crystal displays 11R, 11G and 11B on the screen 14, the present invention is not limited to this example and can be also applied to a direct viewing image display apparatus, a liquid crystal panel of which is a display screen directly viewed by users. Moreover, although the image display apparatus according to the first embodiment is an apparatus for selectively displaying a two-dimensional image or a stereoscopic image, an image display apparatus, to which the present invention is applied, may be a stereoscopic image display apparatus for displaying only a stereoscopic image.

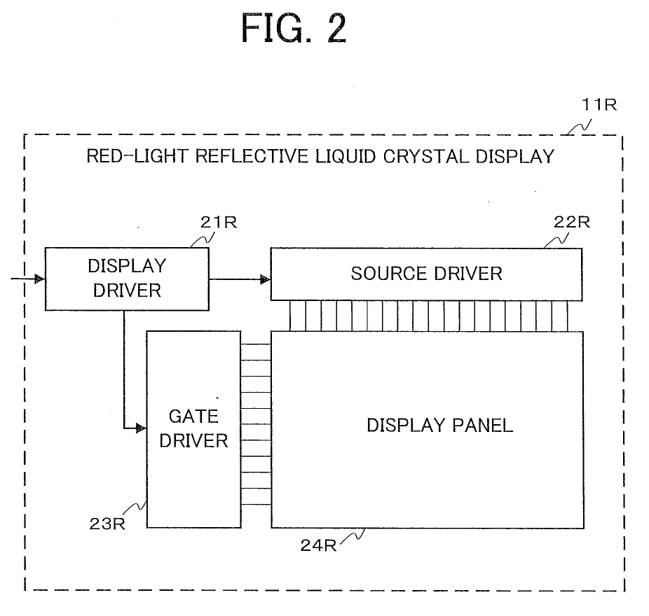

FIG. 2 is a diagram showing an interior configuration of the red-light reflective liquid crystal display 11R in FIG. 1. As shown in FIG. 2, the red-light reflective liquid crystal display 11R includes a display driver 21R, a source driver 22R, a gate driver 23R, and a display panel 24R. Although FIG. 2 shows the red-light reflective liquid crystal display 11R, the green-light reflective liquid crystal display 11G and the blue-light reflective liquid crystal display 11B have a similar configuration to that of the red-light reflective liquid crystal display 11R.

As shown in FIG. 1, the 2D/3D selector 1 switches whether the image display apparatus processes an input image signal as a normal two-dimensional image (2D) signal or as a stereoscopic image (3D) signal. The 2D/3D selector 1 is automatically switched on the basis of information added to the input image signal or is manually switched by a user using an operating panel (not shown in the figure). The 2D/3D selector 1 outputs the input image signal to the 2D double-speed converter 2 when selecting two-dimensional image processing or outputs the input image signal to the 3D double-speed converter 4 when selecting stereoscopic image processing. In the first embodiment, the 2D/3D selector 1 outputs an image mode switching signal indicating which image processing is selected among two-dimensional image processing or stereoscopic image processing to the laser-light-source driver 8. Further, since the image mode switching signal is used when an intensity of the laser light is changed, if an intensity of the laser light is not changed, the 2D/3D selector does not need to output it to the laser-light-source driver 8.

When the 2D/3D selector 1 selects two-dimensional image processing, the 2D double-speed converter 2 converts an input image signal S₂₁ of a frame frequency 60 Hz to a 2D double-speed image signal S₂₂ of a frame frequency 120 Hz. The converted 2D double-speed image signal S₂₂ is input to the 2D timing generator 3. The 2D timing generator 3 generates a liquid crystal display signal P₂₂ₐ used for controlling the reflective liquid crystal displays 11R, 11G and 11B and a laser-light-source driving signal L₂ used for controlling the laser light sources 9R, 9G and 9B. The generated liquid crystal display signal P₂₂ₐ is input to the display controller 7. The display controller 7 supplies the liquid crystal display signal P₂₂ₐ to the reflective liquid crystal displays 11R, 11G and 11B and transmits information indicating that the current displayed image is a two-dimensional image to them. Further, the laser-light-source driving signal L₂ is input to the laser-light-source driver 8. The laser-light-source driver 8 controls on or off of the laser light sources 9R, 9G and 9B so that laser lights are emitted from the laser light sources 9R, 9G and 9B at predetermined drive timing based on the laser-light-source driving signal L₂. Furthermore, although in the above description, the illuminating light sources are the laser light sources, other light sources such as a light emitting diode (LED) or the like may be adopted, if they can control their illuminating operation and emit a high-intensity light.

When the 2D/3D selector 1 selects stereoscopic image processing, the 3D double-speed converter 4 converts an input image signal S₃₁ of a frame frequency 60 Hz to a 3D double-speed image signal S₃₂ of a frame frequency 120 Hz. The converted 3D double-speed image signal S₃₂ is input to the number-of-lines converter 5. The number-of-lines converter 5 converts the number of lines of the input 3D double-speed image signal S₃₂, for example, from 1080 lines to 540 lines (i.e., reduces the number of lines in one frame by half). The 3D double-speed image signal S₃₂ₐ, the number of lines of which is reduced, (also referred to as “3D double-speed image signal S₃₂ₐ of the reduced number of lines) includes a vertical synchronization signal V₃₂ and a double-speed image signal P₃₂ₐ, the number of lines of which is reduced. The 3D double-speed image signal S₃₂ₐ, of the reduced number of lines is input to the 3D timing generator 6. The 3D timing generator 6 generates a liquid crystal display signal P_{32b} used for controlling the reflective liquid crystal displays 11R, 11G and 11B, a laser-light-source driving signal L₃ used for controlling the laser light sources 9R, 9G and 9B, and a 3D information signal I₃ indicating whether the displayed image is an image for left eye or an image for right eye, on the basis of the 3D double-speed image signal S₃₂ₐ of the reduced number of lines. The 3D information signal I₃ is input to the 3D information transmitter 15, and the liquid crystal display signal P_{32b} and the laser-light-source driving signal L₃ are input to the display controller 7 and the laser-light-source driver 8 respectively, in a similar manner to a case where the two-dimensional display mode is selected.

The 3D information transmitter 15 transmits the 3D information to the 3D glasses 16. The 3D glasses 16 change their states in synchronization with the current displayed image to switch the light impinging on a left eye and a right eye. In the first embodiment, the 3D glasses 16 dynamically switch an image reaching an eye between an image for left eye and an image for right eye so that an image for left eye reaches the left eye and an image for right eye reaches the right eye. However, it is also possible to adopt a method in which the 3D glasses 16 do not perform the above-described dynamic switching and polarization direction of the light from the display panel is switched on the basis of whether the displayed image in the image display apparatus is an image for left eye or an image for right eye. In this case, the 3D information output from the 3D information transmitter 15 is not supplied to the 3D glasses 16, but is supplied to a means (not shown in the figure) for switching polarization direction provided in the liquid crystal display apparatus.

Next, optical paths of the laser lights from the laser light sources 9R, 9G and 9B controlled by the laser-light-source driver 8 to the screen 14 will be described. The laser light source 9R emits a red laser light in accordance with control of the laser-light-source driver 8. The red laser light emitted from the laser light source 9R is reflected by the red-light PBS 10R and impinges on the red-light reflective liquid crystal display 11R. The red laser light impinging on the red-light reflective liquid crystal display 11R returns from the red-light reflective liquid crystal display 11R to the red-light PBS 10R, passes through the red-light PBS 10R, and impinges on a red-light incident surface of the cross-dichroic prism 12. The green laser light emitted from the laser light source 9G is reflected by the green-light PBS 10G and impinges on the green-light reflective liquid crystal display 11G. The green laser light impinging on the green-light reflective liquid crystal display 11G returns from the green-light reflective liquid crystal display 11G to the green-light PBS 10G, passes through the green-light PBS 10G, and impinge on a green-light incident surface of the cross-dichroic prism 12. The blue laser light emitted from the laser light source 9B is reflected by the blue-light PBS 10B and impinges on the blue-light reflective liquid crystal display 11B. The blue laser light impinging on the blue-light reflective liquid crystal display 11B returns from the blue-light reflective liquid crystal display 11B to the blue-light PBS 10b, passes through the blue-light PBS 10B, and impinges on a blue-light incident surface of the cross-dichroic prism 12. The cross-dichroic prism 12 combines the input red light, green light and blue light, and outputs the combined light from its emitting surface toward the projection lens 13. The combined light is magnified and projected to the screen 14 by the projection lens 13 to display an image on the screen 14.

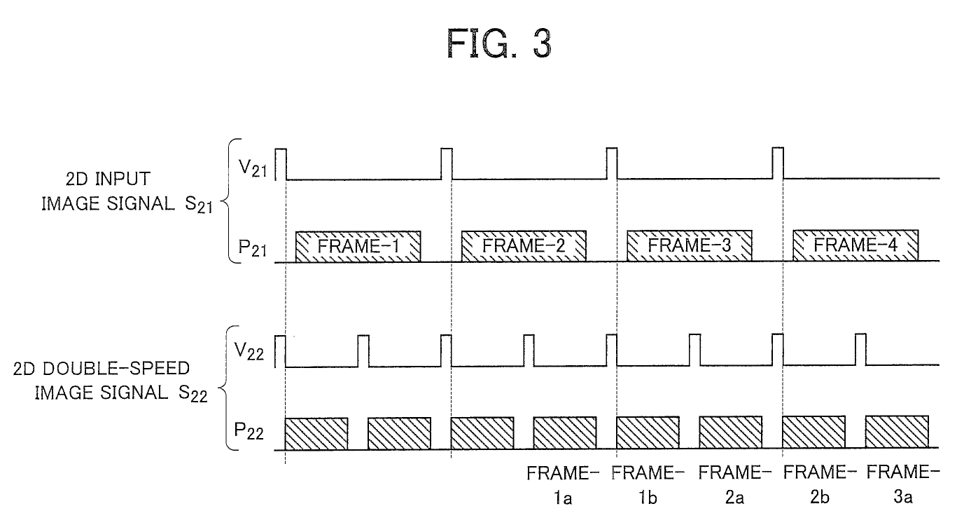

FIG. 3 is a timing diagram showing a 2D input image signal S₂₁ and a 2D double-speed image signal S₂₂ in the 2D double-speed converter 2. The 2D input image signal S₂₁ can be divided into a vertical synchronization signal V₂₁ indicating a boundary between frames and an input image signal P₂₁. In this embodiment, a frequency of the vertical synchronization signal V₂₁ of the 2D input image signal S₂₁ is 60 Hz. A frequency of the vertical synchronization signal V₂₂ of the 2D double-speed image signal S₂₂ is twice as high as that of the vertical synchronization signal V₂₁ of the 2D input image signal S₂₁, that is, 120 Hz. In a similar manner to the vertical synchronization signal V₂₂, a frequency of the double-speed image signal P₂₂ of the 2D double-speed image signal S₂₂ is twice as high as that of the 2D input image signal S₂₁, that is, 120 Hz. In this embodiment, although a frame-1a in the double-speed image signal P₂₂ and a frame-1 in the input image signal P₂₁ has the same image data, a frame-1b in the double-speed image signal P₂₂ is an intermediate image generated (e.g., generated by interpolation processing) from a frame-1 in the input image signal P₂₁ and a frame-2 in the input image signal P₂₁. In this embodiment, since a frame frequency is doubled and the intermediate frames are generated, motion blur that may occur in the reflective liquid crystal displays 11R, 11G and 11B can be reduced.

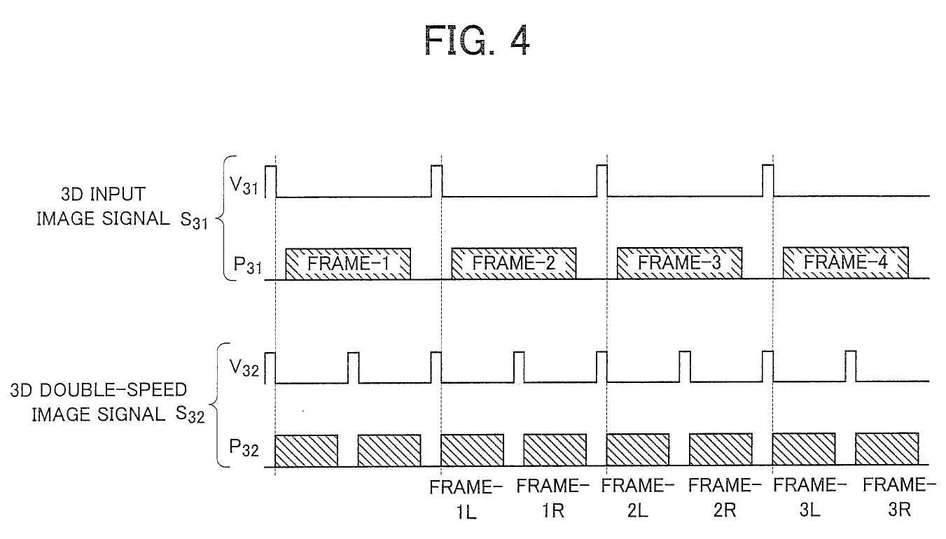

FIG. 4 is a timing diagram showing a 3D input image signal S₃₁ and a 3D double-speed image signal S₃₂ in the 3D double-speed converter 4. In the 3D double-speed image signal S₃₂ in FIG. 4, a frame-1L, a frame-2L, a frame-3L, . . . are frames of an image-for-left-eye signal, and a frame-1R, a frame-2R, a frame-3R, . . . are frames of an image-for-right-eye signal. In a similar manner to the 2D input image signal S21, the 3D input image signal S₃₁ can also be divided into a vertical synchronization signal V₃₁ indicating a boundary between frames and an input image signal P₃₁. In this embodiment, in the double-speed conversion processing by the 3D double-speed converter 4, a vertical synchronization signal V₃₁ of a frequency 60 Hz in the 3D input image signal S₃₁ is converted to a vertical synchronization signal V₃₂ of a frequency 120 Hz, and an input image signal P₃₁ of a frequency 60 Hz in the 3D input image signal S₃₁ is converted to a double-speed image signal P₃₂ of a frequency 120 Hz. When converting the image signal, the 3D double-speed converter 4 extracts part of an image-for-left-eye signal and part of an image-for-left-eye signal from each frame and alternately outputs a frame formed by an image-for-left-eye and a frame formed by an image-for-right-eye signal to generate a signal having a frequency of 120 Hz. As shown in FIG. 4, the 3D double-speed converter 4, for example, generates a frame-1L and a frame-1R of the 3D double-speed image signal S₃₂ from a frame-1 of the 3D input image signal S₃₁. In a similar manner, by generating frames for left eye and for right eye of the 3D double-speed image signal S₃₂ from a single frame of the 3D input image signal S₃₁, an image signal of a frequency of 120 Hz for alternately displaying frames for left eye and for right eye are generated.

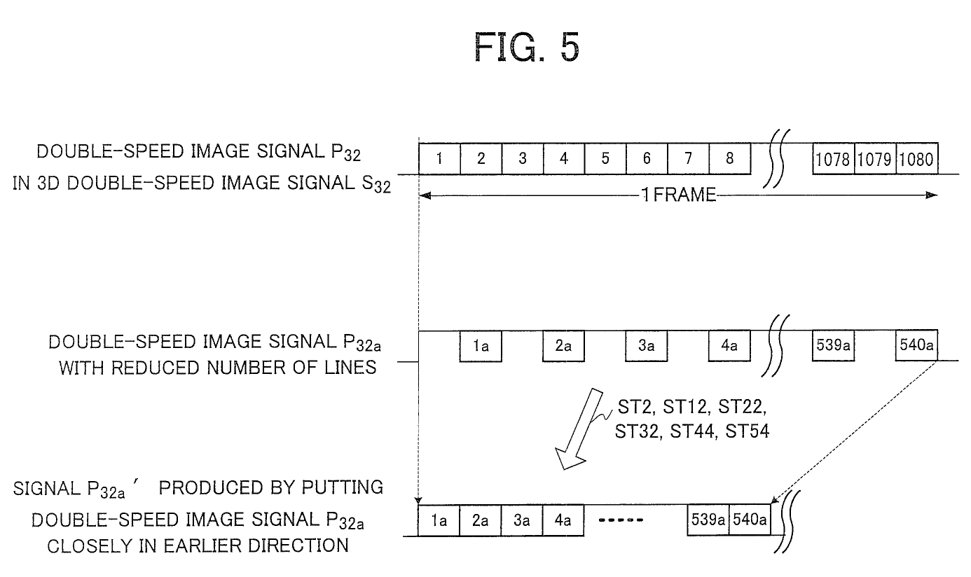

FIG. 5 is an explanatory diagram showing processing for converting the number of lines performed by the number-of-lines converter 5 and processing performed by the 3D timing generator 6. In the processing for converting the number of lines, the number of lines of an image signal P₃₂ in the 3D double-speed image signal S₃₂ input to the number-of-lines converter 5 is converted from 1080 lines to 540 lines, i.e., is reduced by half. In FIG. 5, the line Nos. 1 to 1080 assigned to the image signal P₃₂ in the 3D double-speed image signal S₃₂ indicates the 1st line to the 1080th line in a horizontal scanning direction within one frame. Further, in FIG. 5, numerals 1a to 540a indicate line Nos. assigned to the converted image signal and indicate the 1st line to the 540th line in a horizontal scanning direction within one frame. In an image signal P₃₂ₐ after the number-of-lines conversion processing, the number of lines is reduced by half and therefore the image signal P₃₂ₐ has time gaps in a frame. As shown in FIG. 5, the image signal P₃₂ₐ having the time gaps is put closely in an earlier direction (a left direction in FIG. 5) to remove the time gaps by the 3D timing generator 6, and therefore an image signal P₃₂ₐ′ is generated. Furthermore, the processing for generating image data of line Nos. 1a, 2a, . . . by the 3D timing generator 6 may be processing by a filter for generating a line of line No. 1a from a line of line No. 1 and a line of line No. 2 in order to reduce a delay time, for example. Moreover, if the number of lines to be referenced for generating a new line is increased in the conversion processing, degradation of picture quality can be suppressed and the processing time becomes longer and the time delay is increased. The converted image signal having 540 lines for one frame is input to the 3D timing generator 6. Further, in the first embodiment, although a description will be made as to a case where the number of lines for one frame is reduced by half, the number of lines for one frame may be reduced by other percentages such as one-thirds or the like. If the converted number of lines is small, the laser illuminating time, which will be described below, can be set longer, there is a merit that a brighter image can be displayed but the image quality is degraded.

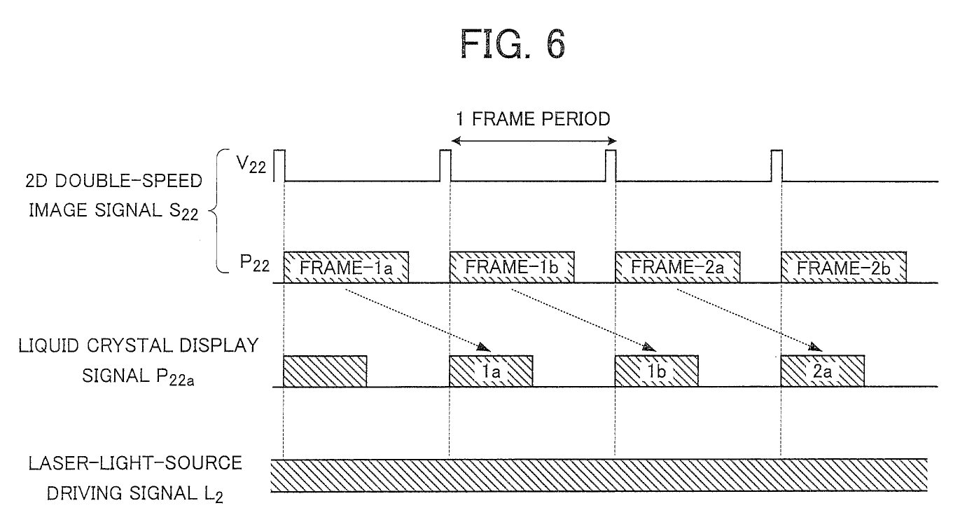

FIG. 6 is a timing diagram showing processing performed by the 2D timing generator 3 in the first embodiment. FIG. 6 shows a 2D double-speed image signal S₂₂, a liquid crystal display signal P₂₂ₐ, and a laser-light-source driving signal L₂ in the first embodiment. An image signal P₂₂ in the input 2D double-speed image signal S₂₂ is converted to a liquid crystal display signal P₂₂ₐ by putting the image signal P₂₂ closely in an earlier direction (i.e., a left direction in FIG. 6) within each frame period (i.e., by increasing a transfer clock frequency) as far as the reflective liquid crystal displays 11R, 11G and 11B can handle. The reason why the image signal P₂₂ is put closely in an earlier direction is that it takes a certain response time depending on the characteristics of the reflective liquid crystal displays 11R, 11G and 11B from a time point when data for one frame based on the liquid crystal display signal P₂₂ₐ is written in the display panel to a time point when the image display for one frame on the display panel is actually completed. The generated liquid crystal display signal P₂₂ₐ is input to the display controller 7. On the other hands the 2D timing generator 3 generates a laser-light-source driving signal L₂ as a timing signal for continuously emitting laser lights. The generated laser-light-source driving signal L₂ is input to the laser-light-source driver 8.

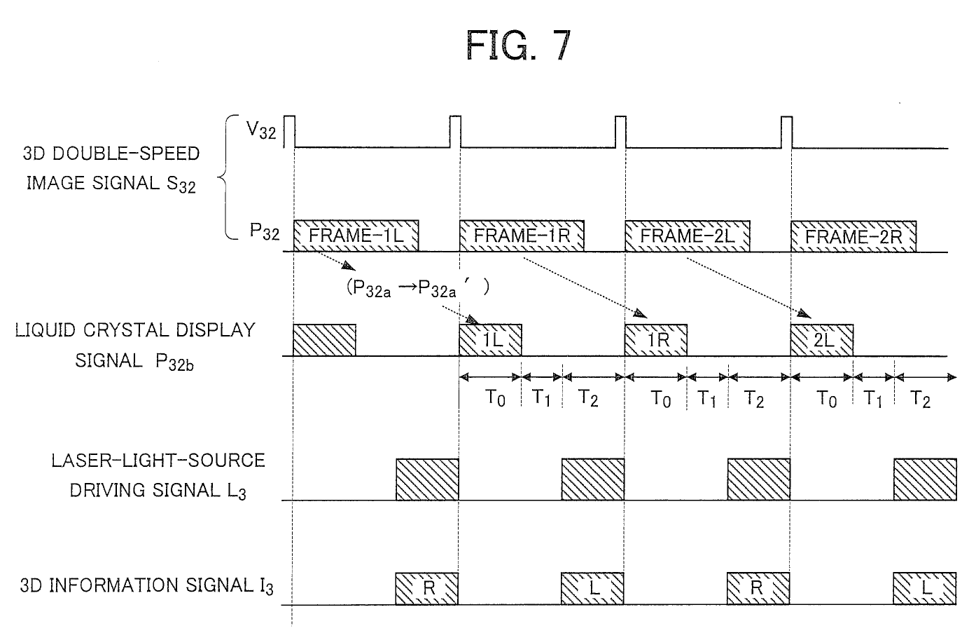

FIG. 7 is a timing diagram showing processing performed by the 3D timing generator 6 in the first embodiment. FIG. 7 shows a 3D double-speed image signal S₃₂, a liquid crystal display signal P₃₂ₐ, a laser-light-source driving signal L₃, and a 3D information signal I₃ in the first embodiment. The 3D timing generator 6 puts the image signal P₃₂ₐ closely in an earlier direction (a left direction in FIG. 5) to remove the time gaps between the lines (e.g., 1a, 2a, 3a, 4a, . . . ) generated by the conversion in the number-of-lines converter 5 from the image signal P₃₂ₐ in the input 3D double-speed image signal (processing shown in FIG. 5), thereby generating an image signal P₃₂ₐ′ (FIG. 5). The image signal P₃₂ₐ′ is converted to a liquid crystal display signal P_{32b} by putting the image signal P₃₂′ closely in an earlier direction (a left direction in FIG. 7) within each frame period (i.e., by increasing a transfer clock frequency) as far as the reflective liquid crystal displays 11R, 11G and 11B can handle, and the liquid crystal display signal P_{32b} is transmitted to the display controller 7. Since the number of lines is reduced through the conversion by the number-of-lines converter 5 (reduced by half in the first embodiment), an effective period T₀ of the liquid crystal display signal P_{32b} for one frame is shorter than an effective period of the liquid crystal display signal P₂₂ₐ generated by the 2D timing generator 3 for one frame. For this reason, it is possible to make a period T₂, which is from a time point when a prescribed response time T₁ in the reflective liquid crystal displays 11R, 11G and 11B was elapsed to a time point when a liquid crystal display signal for the next frame becomes effective, longer.

Further, a laser-light-source driving signal L₃ is a signal having the same period as the effective period T₂ from a time point when a prescribed response time T₁ in the reflective liquid crystal displays 11R, 11G and 11B was elapsed (i.e., after image display for one frame on the display panel was completed) to a time point when a liquid crystal display signal for the next frame becomes effective. By using this laser-light-source driving signal L₃, crosstalk between an image for left eye and an image for right eye can be avoided. The reason why the laser light sources 9R, 9G and 9B are turned on after the prescribed response time T₁ was elapsed is as follows. A response time in the reflective liquid crystal displays 11R, 11G and 11B is not always constant, and changes depending on a difference between a value (brightness) before data rewriting and a value (brightness) after data rewriting. For this reason, if the laser light sources 9R, 9G and 9B are turned on before a prescribed response time T₁ that has been determined in advance was elapsed, there is a possibility of displaying uneven image between first areas of the reflective liquid crystal displays 11R, 11G, and 11B, in which data is rewritten in an earlier time for one frame and/or in which data pattern is one having a fast response time and second areas other than the first areas. Furthermore, a reason why the effective period T₂ is set to a period before the liquid crystal display signal for the next frame becomes effective is as follows. If the laser light sources 9R, 9G and 9B are in an on-state for a period longer than the effective period T₂, part of the displayed image of the next frame is superimposed on the displayed image of the current frame and therefore crosstalk between an image for left eye and an image for right eye occurs.

Further, since in the stereoscopic image processing, the laser light sources 9R, 9G and 9B illuminate light intermittently, even if the illuminating time is set to be a maximum value, the displayed image becomes darker than that in the two-dimensional image processing when the laser light sources illuminate light continuously. For this reason, the laser-light-source driver 8 may be configured so that it can control the output intensities of the laser light sources 9R, 9G and 9B in addition to on-off timing of the laser light sources 9R, 9G and 9B. When the laser light sources 9R, 9G and 9B are adopted as light sources, there is a merit that it becomes easy to control intermittent illumination and/or detail adjustment of the output intensity. Therefore, in the stereoscopic image processing, it is possible to temporarily increase the output intensity of the light sources so that the brightness of the displayed image becomes substantially the same as that in the two-dimensional image processing. Although the power supply performance of a power source unit for supplying power to the laser light sources must be improved in order to increase the output intensity of the laser light sources 9R, 9G and 9B, there is no need to increase the output intensity of the laser light sources 9R, 9G and 9B by a large amount in the first embodiment, because processing for changing the number of lines to a reduced number of lines is performed by the number-of-lines converter 5 and the illuminating time of the laser light sources 9R, 9G and 9B can be longer. By using such control, the reduction of the brightness that may occur when the laser light sources 9R, 9G and 9B are intermittently turned on can be suppressed. The generated laser-light-source driving signal L₃ is input to the laser-light-source driver 8.

Further, the 3D timing generator 6 generates a 3D information signal I₃. The 3D information signal I₃ is a signal indicating whether the current displayed image is an image for left eye or an image for right eye. In the 3D information signal I₃ in FIG. 7, parts assigned by a character ‘R’ indicate a frame of an image-for-right-eye signal, and parts assigned by a character ‘L’ indicate a frame of an image-for-left-eye signal. Since an image displayed on the display panel is projected on the screen 14 after the illuminating of the laser light, the 3D information signal I₃ is output in connection with the output of the laser-light-source driving signal L₃. In the first embodiment, although an effective time of the laser-light-source driving signal L₃ coincides with an effective time of the 3D information signal I₃ completely, a constant or variable time difference may be provided between them in consideration of the switching response time of the 3D glasses 16 that finally receive the 3D information signal I₃. The 3D information signal I₃ is input to the 3D information transmitter 15.

The liquid crystal display signal and the current display mode (2D/3D) output from the display controller 7 shown in FIG. 1 is input to, for example, the display driver 21R of red-light reflective liquid crystal display 11R in FIG. 2. When the current display mode is a 2D mode, that is, a two-dimensional image mode, the display driver 21R causes the gate driver 23R to designate one line, to which data is to be written, in the a display panel 24R, thereby making the designated line a data rewritable state. On the other hand, the display driver 21R causes the source driver 22R to write image data to one line, to which data is to be written. The display driver 21R controls the gate driver 23R and the source driver 22R so that data are written line by line sequentially to display an image on the display panel 24R.

When the display driver 21R receives a stereoscopic image signal as a current display mode from the display controller 7, the display driver 21R causes the gate driver 23R to designate two lines (which is twice as in the case of two-dimensional display) as the lines in a display panel 24R, to which data is to be written, and gives an image data for one line to the source driver 22R. By this processing, the same image data are written in two neighboring lines in the display panel 24R. The reason why the same image data are written in two lines is that the number of lines is reduced by half by the number-of-lines converter 5 in FIG. 1 and therefore it is necessary to double the image data when the image data is written to the display panel 24R. Although the number of lines is reduced by half and a resolution is also reduced by half, the number of process for writing the image data to the source driver 22R can be reduced by half and time used for writing image data in the display panel 24R can be shortened. Further, the green-light and blue-light reflective liquid crystal displays 11G and 11B also operates in a similar manner.

As has been described above, in the image display apparatus and the image display method of the first embodiment, since the time gaps in an image-for-left-eye signal of the reduced number of lines and an image-for-right-eye signal of the reduced number of lines are removed (in addition, if necessary, by using higher clock frequency to reduce the transmitting time) and then they are transmitted to the reflective liquid crystal display panels 11R, 11G and 11B, the receiving time for an image signal can be shortened. Further, in the image display apparatus and the image display method of the first embodiment, since the display unit duplicates an image signal of each line of the image-for-left-eye signal of the reduced number of lines and the image-for-right-eye signal of the reduced number of lines supplied from the display controller to produce the same plural image signals for plural lines and simultaneously writes the produced plural image signals for plural lines in the reflective liquid crystal display panels 11R, 11G, 11B to display an image, the writing time in the display panel can be shortened. For these reasons, the image display apparatus and the image display method of the first embodiment can have an advantageous effect that the laser light sources 9R, 9G and 9B can illuminate the display panels for longer time T₂ as long as crosstalk between an image for left eye and an image for right eye can be avoided, an bright image can be displayed on the display panel and crosstalk between an image for left eye and an image for right eye can be avoided. Furthermore, since there is no need to provide plural light sources corresponding to plural lines respectively, the present invention has an advantageous effect that the apparatus does not need to have a complicate configuration.

### Second Embodiment

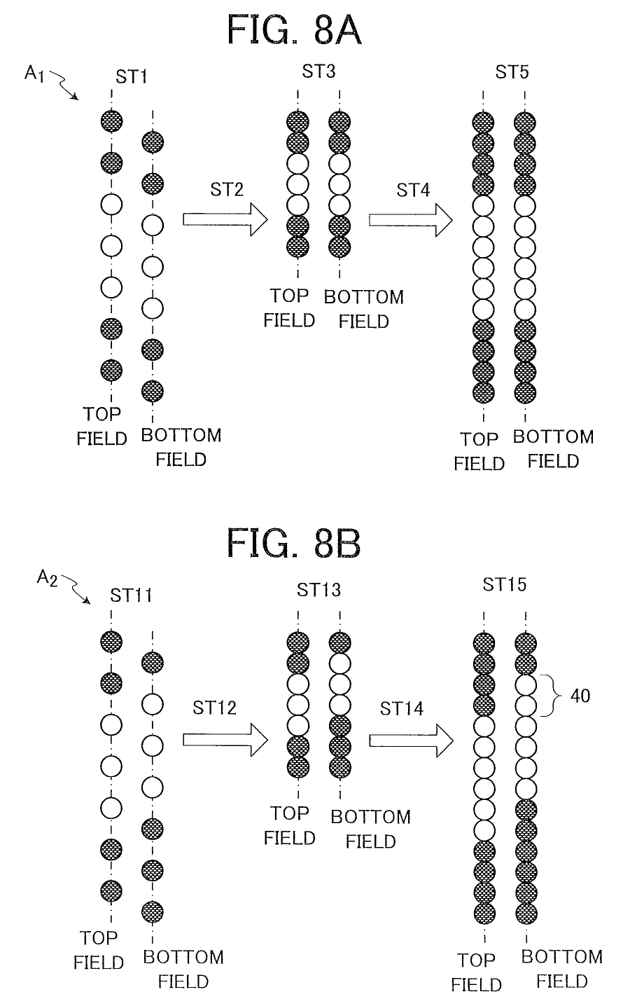

FIGS. 8A and 8B are explanatory diagrams showing a case where a stereoscopic image signal is an interlace signal in an image display apparatus according to the second embodiment (i.e., an apparatus for performing an image display method according to the second embodiment) of the present invention. Although the first embodiment describes a case where the input image signal is a non-interlace signal, the present invention can be applied to a case where the input image signal is an interlace signal. The second embodiment is the same as the first embodiment except for a point that the input image signal in the first embodiment is a non-interlace signal. Therefore, a description of the second embodiment will be made also with reference to FIG. 1.

A description will be made as to only an image for left eye of an interlace signal that has been converted to 120 Hz by the 3D double-speed converter 4. Regarding only an image for left eye in a 3D double-speed image signal of a frequency 120 Hz, it can be regarded as an interlace signal of a frequency 60 Hz. FIGS. 8A and 8B each show a series of flow including processing for changing the number of lines to a reduced number of lines (ST1, ST11) by the number-of-lines converter 5 when an image-for-left-eye signal is an interlace signal, processing (ST2, ST3, ST12, ST13) for putting the image-for-left-eye signal of the reduced number of lines closely in an earlier direction (in an upward direction in FIGS. 8A and 8B) in the 3D timing generator 6, and processing (ST4, ST5, ST14, ST15) for writing an image data in the display panel by the display driver 21R of the red-light reflective liquid crystal display 11R. In the case of an interlace signal, since the number of lines in each field is half of the number of lines in a frame, additional thinning processing by the number-of-lines converter 5 is not necessarily required. In the case of an interlace signal, processing for changing the number of lines to a reduced number of lines by the number-of-lines converter 5 is, for example, processing for using alternately any one of a top field signal and a bottom field signal as an image signal of the reduced number of lines (shown in FIGS. 8A and 8B as ST1 and ST11).

The patterns A₁ and A₂ shown in FIGS. 8A and 8B are display patterns, in which a line flicker between a top field line and a bottom field line which may occur when two lines of image data are written in the display panel at a time is not noticeable. The shaded dots and the white dots in a top field and a bottom field indicate black image data and white image data in each line respectively. As shown as processing ST4, ST5 and ST14, ST15 in FIGS. 8A and 8B, the red-light reflective liquid crystal display 11R duplicates the image data to produce the two lines of image data (the image data (ST3) and the generated image data (ST5) for two neighboring lines) and writes two lines of image data in the display panel at a time (ST5). Further, the green-light reflective liquid crystal display 11G and the blue-light reflective liquid crystal display 11B perform substantially the same processing as the red-light reflective liquid crystal display 11R.

As has been described above, the image display apparatus and the image display method according to the second embodiment can have advantageous effects similar to those in the first embodiment.

### Third Embodiment

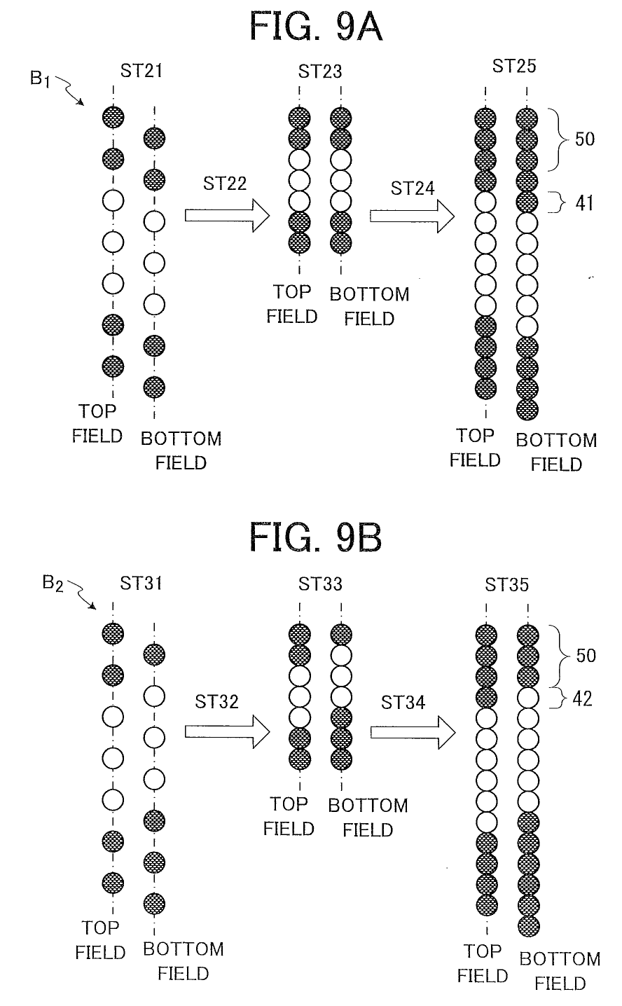

FIGS. 9A and 9B are explanatory diagrams showing a case where a stereoscopic image signal is an interlace signal in an image display apparatus according to the third embodiment (i.e., an apparatus for performing an image display method according to the third embodiment) of the present invention. In the third embodiment, a measure for reducing the line flicker is provided in addition to the constitutional elements of the second embodiment. Except for this point, the third embodiment is substantially the same as the above-described second embodiment.

In the above-described second embodiment, as shown as pattern A₂ in FIG. 8B, when a line, on which the image data changes from a black picture element shown by a shaded dot to a white picture element shown by a white dot, is the 3rd line in a top field and the 2nd line in a bottom field, the line flicker may be noticeable occasionally. This is because as shown as numeral 40 in FIG. 8B, when a line (ST13) to be displayed is duplicated to produce two lines and these two line are simultaneously written in the reflective liquid crystal display (ST14, ST15), two lines generated by the 2nd line in a top field (ST13) are black lines and two lines generated by the 2nd line in a bottom field (ST13) are white lines, and therefore there are undesirably two lines 40 that are alternately displayed as the black lines and the white lines.

For this reason, in the third embodiment, as shown in FIGS. 9A and 9B, when the display driver 21R in the red-light reflective liquid crystal display 11R, instead of duplicating the 1st line in a bottom field to two lines, the 1st line in a bottom field is changed to three lines (shown by numeral 50) to be written in the display panel. Further, although FIGS. 9A and 9B do not show, the last line of a bottom field is not duplicated to produce two lines, the data of the last line is written in the display panel as it is. Since it is one line that is alternately displayed as a black line and a white line as shown as numeral 42 of pattern B₂ in FIG. 9B, a line flicker can be reduced by half in comparison with a case of FIG. 8B where it is two neighbor lines that are alternately displayed as black lines and white lines as shown as numeral 42 of pattern A₂ in FIG. 8B.

Although a line flicker does not occur in pattern A₁ of FIG. 8A, one line of line flicker may occur in this embodiment as shown as numeral 41 of pattern B₁ in FIG. 9A. However, in the case shown in FIGS. 8A and 8B, since there are both an area, at which a line flicker is extremely noticeable due to line flickers at two neighbor lines, and another area, at which no line flicker exists, the line flicker is noticeable in one frame, it seems that a level of user's unpleasant feeling increases. For this reason, it seems that the conversion processing shown in FIGS. 9A and 9B that permits small line flickers that may appear in the whole frame are more preferable.

As has been described above, the image display apparatus and the image display method according to the third embodiment can have advantageous effects similar to those in the second embodiment as well as another effect that the noticeable line flicker can be lessened.

### Fourth Embodiment

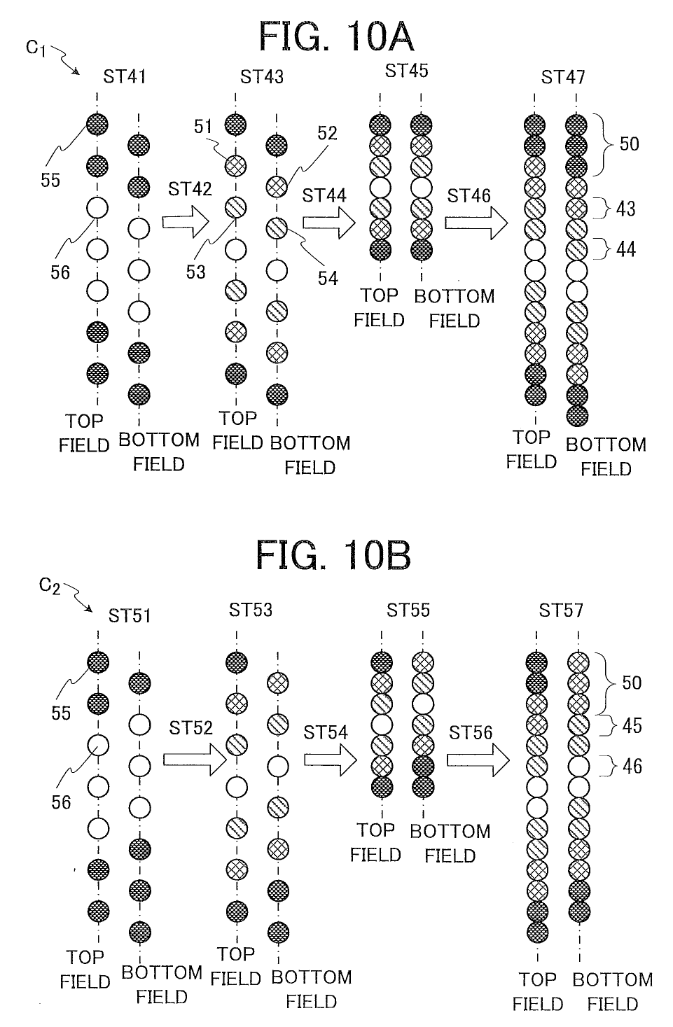

FIGS. 10A and 10B are explanatory diagrams showing a case where a stereoscopic image signal is an interlace signal in an image display apparatus according to the fourth embodiment (i.e., an apparatus for performing an image display method according to the fourth embodiment) of the present invention. In the fourth embodiment, a measure for reducing the line flicker still more is provided in addition to the constitutional elements of the third embodiment. Except for this point, the fourth embodiment is substantially the same as the above-described third embodiment.

In FIGS. 10A and 10B, shaded dots 55 indicate picture elements of the lowest gradation level, cross-hatched dots 51 and 52 indicate picture elements of low gradation level (first halftone gradation), hatched dots 53 and 54 indicate picture elements of the second highest gradation level (second halftone gradation) higher than the first gradation level, and white dots 56 indicate picture elements of the highest gradation level. In the fourth embodiment, as shown in FIGS. 10A and 10B, there is provided a filter (5a in FIG. 1) for filter processing in the image display apparatus. When a black picture element and a white picture element neighbor to each other in a vertical scanning direction in a top field or a bottom field, the filter converts a black picture element as one of the neighboring picture elements to a first picture element (numeral 51 or 52) of low gradation level (first halftone gradation) and converts a white picture element as another one of the neighboring picture elements to a second picture element (numeral 53 or 54) of the second highest gradation level (second halftone gradation) higher than the first gradation level. This filter is provided in, for example, the number-of-lines converter 5. However, the filter may be in the 3D timing generator 6. In this case, the filter may perform filter processing after processing for putting an image signal of the reduced number of lines closely in an earlier direction.

Since the areas whose gradation changes from white to black or from black to white in a vertical scanning direction can be displayed by picture elements of halftone gradation color (numerals 43, 44 in FIG. 10A and numerals 45, 46 in FIG. 10B) through the above filter processing, noticeable line flicker can be more lessened. However, in this case, since gradation from white to black or from black to white changes gradually, the resolution decreases. Therefore, the image display apparatus may be configured so that the processing mode can be switched depending on which the lessening of the line flicker or the increase of the resolution is more important.

As has been described above, in the image display apparatus and the image display method according to the fourth embodiment, the advantageous effects similar to those of the second and third embodiments can be obtained and another effect that line flicker can be reduced still more.

Further, the image display method using picture elements of halftone gradation in the fourth embodiment can be applied to the first and second embodiments.

### Fifth Embodiment

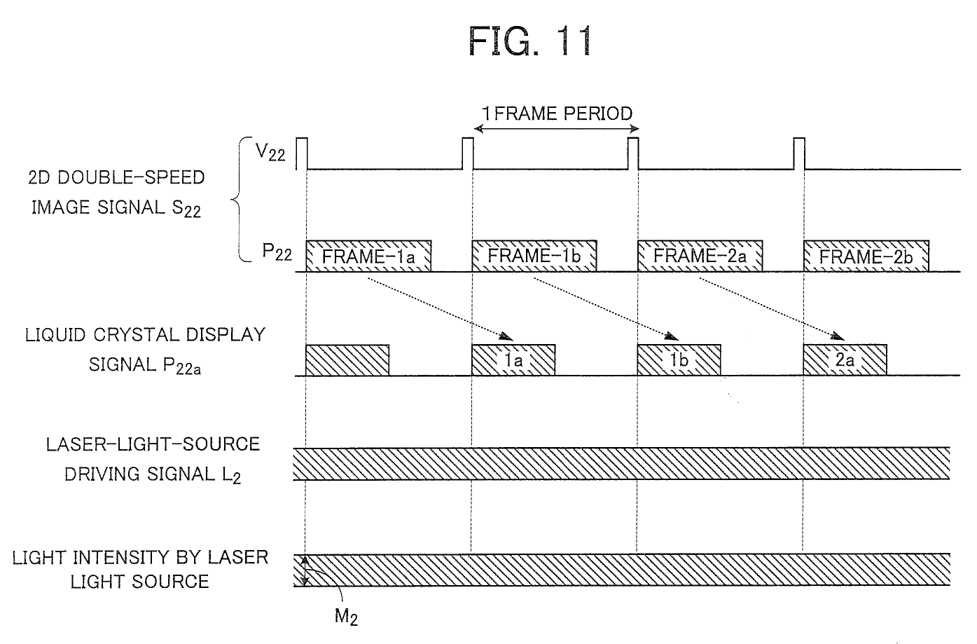

FIG. 11 is a timing diagram showing the 2D display in an image display apparatus according to the fifth embodiment (i.e., an apparatus for performing an image display method according to the fifth embodiment) of the present invention, and is a diagram corresponding to FIG. 6 in the first embodiment. The fifth embodiment is substantially the same as the first embodiment except for a point that each light emitting level of the laser light sources is controlled. Therefore, the fifth embodiment will be described using the same reference characters as those of the first embodiment. A difference between FIG. 11 and FIG. 6 is that FIG. 11 shows a light emitting level M₂ of the laser light source. The light emitting level M₂ of the laser light source is controlled by the laser-light-source driver 8 to adjust the intensity of the laser light emitted from the laser light source, and when the two-dimensional image processing is selected, each light emitting level of the laser light sources is set so that each laser light is continuously emitted at a constant normal level.

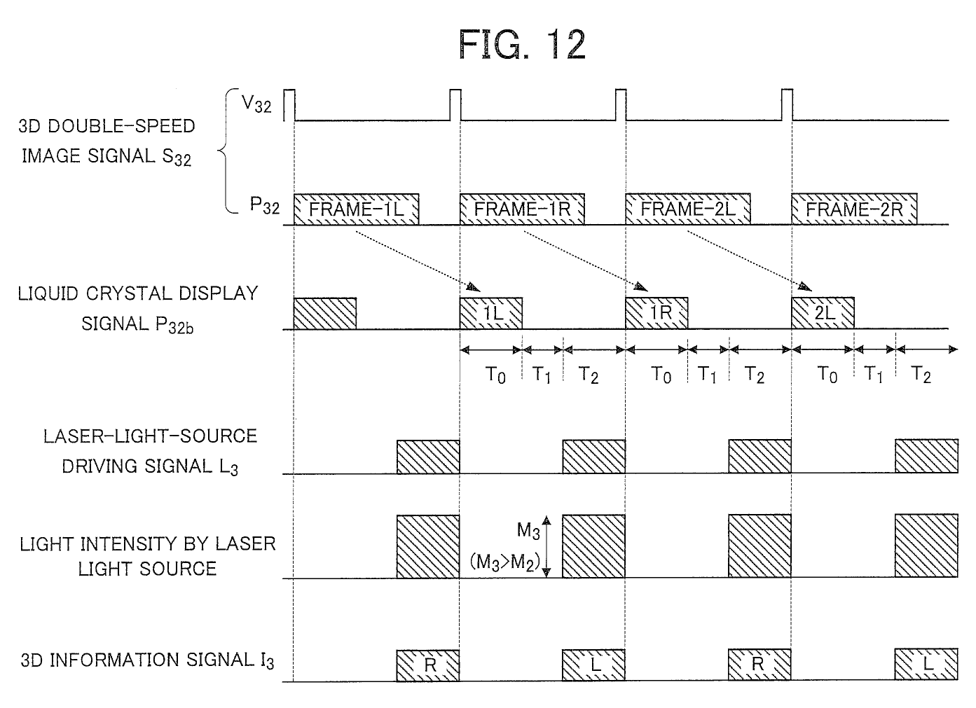

FIG. 12 is a timing diagram showing the 3D display in the fifth embodiment, and is a diagram corresponding to FIG. 7 in the first embodiment. A difference between FIG. 12 and FIG. 7 is that a light emitting level M₃ of the laser light source is added. A relationship between the light emitting level M₃ of the laser light source in FIG. 12 and the light emitting level M₂ of the laser light source in FIG. 11 will be described. Since the laser light sources 9R, 9G and 9B emit the laser lights intermittently during stereoscopic image processing, even if the illuminating time is set to long time, a displayed image is darker than that in the two-dimensional image processing in which the laser light sources emit lights continuously. For this reason, in the fifth embodiment, the laser-light-source driver 8 is configured so as to be able to control the outputs of the laser light sources 9R, 9G and 9B in addition to the illumination timings of the laser light sources 9R, 9G and 9B. To be concrete, when each of the laser light sources 9R, 9G and 9B emits the laser light intermittently during the stereoscopic image processing, the light emitting level M₃ of the laser light source is controlled to be set to a higher level than the light emitting level M₂ of the laser light source. Since the intermittent illumination and the fine adjustment of the output intensity are easy when the laser light sources 9R, 9G and 9B are used, it is possible to increase the output intensity of the laser light temporarily so that the brightness of the displayed image during the stereoscopic image processing becomes the same level as the brightness of the displayed image during the two-dimensional image processing. In order to increase the output intensity of the laser light sources 9R, 9G and 9B, it is necessary to improve power supply performance of the power source unit for supplying power to the laser light source. However, since it is enough to increase the light emitting intensity only during illumination time in the intermittent illumination and continuous illumination for a long time is not necessary, the power supply performance required for the power source unit is not very large. By adopting the above-described control, the reduction of the displayed image due to the intermittent illumination of the light source can be avoided.

As has been described above, in the image display apparatus and the image display method according to the fifth embodiment, since the light emitting intensity of the laser light source when the laser light source emits light intermittently in order to avoid the crosstalk between an image for left eye and an image for right eye when the stereoscopic image is displayed is temporarily set to a higher level that when the two-dimensional image is displayed, there is an effect that crosstalk between an image for left eye and an image for right eye can be avoided while implementing approximately the same brightness of the displayed image as the case of the two-dimensional image display. Further, since there is no need to provide plural light sources corresponding to plural lines respectively, the image display apparatus and the image display method according to the fifth embodiment has an advantageous effect that the apparatus does not need to have a complicate configuration.

The invention being thus described, it will be obvious that the same may be varied in many ways. Such variations are not to be regarded as a departure from the spirit and scope of the invention, and all such modifications as would be obvious to one skilled in the art are intended to be included within the scope of following claims.

What is claimed is:

1. An image display apparatus comprising:
a display unit including a display panel for displaying an image;
an illuminator for applying light to the display panel;
a number-of-lines converter for receiving an image-for-left-eye signal and an image-for-right-eye signal of a stereoscopic image and for changing each of number of lines in one frame of the image-for-left-eye signal and number of lines in one frame of the image-for-right-eye signal to a reduced number of lines;
a timing generator for generating a display timing signal and an illuminating timing signal on the basis of the image-for-left-eye signal of the reduced number of lines and the image-for-right-eye signal of the reduced number of lines;
a display controller for alternately supplying the image-for-left-eye signal of the reduced number of lines or the image-for-right-eye signal of the reduced number of lines at timing synchronized with the display timing signal to the display unit every one frame; and
an illuminator driver for causing the illuminator to apply light to the display panel at timing synchronized with the display timing signal every one frame;
wherein the display unit duplicates an image signal of each line of the image-for-left-eye signal of the reduced number of lines and the image-for-right-eye signal of the reduced number of lines supplied from the display controller to produce the same plural image signals for plural lines and simultaneously writes the produced plural image signals for plural lines in the display panel to display an image.

2. The image display apparatus according to claim 1, wherein the illuminating timing signal is a signal indicating a period from a time point when an image signal of a frame is written in the display panel and an image based on the written image signal is displayed on the display panel to a time point immediately before another frame next to the frame starts.

3. The image display apparatus according to claim 1, wherein the changing of the number of lines in one frame to the reduced number of lines by the number-of-lines converter is performed by cutting even lines or odd lines in one frame.

4. The image display apparatus according to claim 1, wherein the display unit is a reflective liquid crystal display unit.

5. The image display apparatus according to claim 1, wherein:
the illuminator includes a laser light source; and
the light emitted from the illuminator is a laser light emitted from the laser light source.

6. The image display apparatus according to claim 1, wherein:
the illuminator includes a light emitting diode; and
the light emitted from the illuminator is a light emitted from the light emitting diode.

7. The image display apparatus according to claim 1, wherein:
the changing of the number of lines in one frame to the reduced number of lines by the number-of-lines converter is performed by reducing the number of lines in one frame by half; and
the producing of the same plural image signals for plural lines in the display unit is performed by duplicating an image signal for one line to produce the same two image signals for two lines.

8. The image display apparatus according to claim 1, wherein:
each of the image-for-left-eye signal and the image-for-right-eye signal forms an interlace signal, in which one frame is composed of a top field and a bottom field, and
only when the display unit produces the same plural image signals for plural lines from an image signal of the 1st line in a bottom field, the producing of the same plural image signals for plural lines in the display unit is performed by duplicating an image signal for one line to produce the same three image signals for three lines.

9. The image display apparatus according to claim 8, further comprising a filter, wherein when a black picture element and a white picture element neighbors to each other in a vertical scanning direction in a top field or a bottom field, the filter converts the neighboring black picture element to a first picture element having a first intermediate gradation level and converts the neighboring white picture element to a second picture element having a second intermediate gradation level lower than the first intermediate gradation level.

10. The image display apparatus according to claim 1, further comprising a display image mode selector for selecting a display image mode of the display unit between a two-dimensional image or the stereoscopic image;
wherein:
when the display image mode selector selects a two-dimensional image display mode as the display image mode of the display unit, the illuminator driver causes the illuminator to continuously illuminating at a first illuminating intensity to continuously apply light to the display panel; and
when the display image mode selector selects a stereoscopic image display mode as the display image mode of the display unit, the illuminator driver causes the illuminator to intermittently illuminating at a second illuminating intensity higher than the first illuminating intensity so as to illuminate within a period when the image for right eye or the image for left eye is displayed on the display panel and so as not to illuminate without the period, thereby intermittently applying light to the display panel.

11. An image display method comprising:
a step, in which a number-of-lines converter receives an image-for-left-eye signal and an image-for-right-eye-signal of a stereoscopic image and changes each of number of lines in one frame of the image-for-left-eye signal and number of lines in one frame of the image-for-right-eye signal to a reduced number of lines;
a step, in which a timing generator generates a display timing signal and an illuminating timing signal on the basis of the image-for-left-eye signal of the reduced number of lines and the image-for-right-eye signal of the reduced number of lines;
a step, in which a display unit including a display panel alternately receives the image-for-left-eye signal of the reduced number of lines or the image-for-right-eye signal of the reduced number of lines at timing synchronized with the display timing signal every one frame, and duplicates an image signal of each line of the image-for-left-eye signal of the reduced number of lines and the image-for-right-eye signal of the reduced number of lines supplied from the display controller to produce the same plural image signals for plural lines and simultaneously writes the produced plural image signals for plural lines in the display panel to display an image; and
a step, in which an illuminator applies light to the display panel for each one frame at timing synchronized with the illuminating timing signal.

12. The image display method according to claim 11, wherein the illuminating timing signal is a signal indicating a period from a time point when an image signal of a frame is written in the display panel and an image based on the written image signal is displayed on the display panel to a time point immediately before another frame next to the frame starts.

13. The image display method according to claim 11, wherein the changing of the number of lines in one frame to the reduced number of lines by the number-of-lines converter is performed by cutting even lines or odd lines in one frame.

14. The image display method according to claim 11, wherein:
the changing of the number of lines in one frame to the reduced number of lines by the number-of-lines converter is performed by reducing the number of lines in one frame by half; and
the producing of the same plural image signals for plural lines in the display unit is performed by duplicating an image signal for one line to produce the same two image signals for two lines.

15. The image display method according to claim 11, wherein
each of the image-for-left-eye signal and the image-for-right-eye signal forms an interlace signal, in which one frame is composed of a top field and a bottom field, and
only when the display unit produces the same plural image signals for plural lines from an image signal of the 1st line in a bottom field, the producing of the same plural image signals for plural lines in the display unit is performed by duplicating an image signal for one line to produce the same three image signals for three lines.

16. The image display method according to claim 15, wherein when a black picture element and a white picture element neighbors to each other in a vertical scanning direction in a top field or a bottom field, the filter converts the neighboring black picture element to a first picture element having a first intermediate gradation level and converts the neighboring white picture element to a second picture element having a second intermediate gradation level lower than the first intermediate gradation level.

17. The image display method according to claim 11, further comprising a step, in which the display image mode selector for selecting a display image mode of the display unit between a two-dimensional image or the stereoscopic image;
the method further comprising:
a step, in which when the display image mode selector selects a two-dimensional image display mode as the display image mode of the display unit, the illuminator driver causes the illuminator to continuously illuminating at a first illuminating intensity to continuously apply light to the display panel; and
a step, in which when the display image mode selector selects a stereoscopic image display mode as the display image mode of the display unit, the illuminator driver causes the illuminator to intermittently illuminating at a second illuminating intensity higher than the first illuminating intensity so as to illuminate within a period when the image for right eye or the image for left eye is displayed on the display panel and so as not to illuminate without the period, thereby intermittently applying light to the display panel.
